(19) United States
(12) Patent Application Publication
(10) Pub. No.: US 2026/0124939 A1
(43) Pub. Date: May 7, 2026

(54) BATTERY CHARGING SYSTEM INCLUDING ISOLATED POWER SPLITTER OPERATING IN SIMULTANEOUS CHARGING AND DISCHARGING MODE

(71) Applicant: GM GLOBAL TECHNOLOGY OPERATIONS LLC, Detroit, MI (US)

(72) Inventors: Minh-Khai NGUYEN, Troy, MI (US); Firas SHABO, Shelby Township, MI (US); Brian A. WELCHKO, Oakland Township, MI (US)

(21) Appl. No.: 18/934,604

(22) Filed: Nov. 1, 2024

(51) Int. Cl. B60L 53/22; B60L 55/00; H02J 7/00; H02J 7/06; H02M 1/44

(52) U.S. Cl. CPC B60L 53/22; B60L 55/00; H02J 7/06; H02J 7/865; H02M 1/44; B60L 2210/22; H02J 2207/20

(57) ABSTRACT

A battery charging system for a vehicle includes a multi-port transformer including first, second, and third windings. A first converter is connected to the first windings and includes a first plurality of switches. A second converter is connected to the second windings and a battery and includes a second plurality of switches. A third converter is connected to the third windings and to an alternating current (AC) power outlet and includes a third plurality of switches. A first plurality of configuration switches is configured to selectively connect the first converter to a charge port. A controller is configured to control the first, second, and third plurality of switches of the first, second, and third converters, the first plurality of configuration switches, and the second plurality of configuration switches to select one of a plurality of charging modes of the battery charging system.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a battery charging system including an isolated power splitter.

Electric vehicles (EVs) such as battery electric vehicles (BEVs), hybrid vehicles, and/or fuel cell vehicles include one or more electric machines and a battery including one or more battery cells, modules, and/or packs. A battery charging system is used to control charging from an alternating current (AC) grid or supplying power from the battery to the AC grid or another load.

### SUMMARY

A battery charging system for a vehicle includes a multi-port transformer including first windings, second windings, and third windings wound around a common core. A first converter is connected to the first windings and includes a first plurality of switches. A second converter is connected to the second windings and a battery and includes a second plurality of switches. A third converter is connected to the third windings and to an alternating current (AC) power outlet and includes a third plurality of switches. A first plurality of configuration switches is configured to selectively connect the first converter to a charge port. A controller is configured to control the first plurality of switches of the first converter, the second plurality of switches of the second converter, the third plurality of switches of the third converter, the first plurality of configuration switches, and the second plurality of configuration switches to select one of a plurality of charging modes of the battery charging system.

In other features, a ground fault circuit interrupter (GFCI) connected between the third converter and the AC power outlet. A second plurality of configuration switches is configured to selectively connect the first converter to the second converter. A third plurality of configuration switches is configured to selectively connect the third converter to the AC power outlet.

In other features, the plurality of charging modes include a charging mode for charging the battery, a charging/discharging mode for charging the battery from an AC grid via the charge port while supplying power to the AC power outlet, and a discharging/discharging mode for discharging the battery to a load via the charge port while supplying power to the AC power outlet.

In other features, during the charging mode, the controller is configured to close the first plurality of configuration switches and the second plurality of configuration switches and open the third plurality of configuration switches. During the charging mode, the controller is configured to control the first plurality of switches, the second plurality of switches, and the third plurality of switches to supply current from the AC grid through the charge port, the first converter and the second converter to the third converter and the battery.

In other features, during the charging/discharging mode, the controller is configured to close the first plurality of configuration switches and the third plurality of configuration switches and open the second plurality of configuration switches.

In other features, during the charging/discharging mode, the controller is configured to control the first plurality of switches, the second plurality of switches, and the third plurality of switches to supply current from the AC grid through the first converter to the second converter and the battery and through the first converter and the third converter to the AC power outlet.

In other features, during the discharging/discharging mode, the controller is configured to close the first plurality of configuration switches and the third plurality of configuration switches and open the second plurality of configuration switches.

In other features, during the discharging/discharging mode, the controller is configured to control the first plurality of switches, the second plurality of switches, and the third plurality of switches to supply current from the battery through the second converter, the first converter, and the charge port and through the second converter and the third converter to the AC power outlet.

In other features, the AC grid supplies three-phase AC current. The AC grid supplies single-phase AC current.

A battery charging system for a vehicle includes a multi-port transformer including first windings, second windings, and third windings wound around a common core. A first converter is connected to the first windings and includes a first plurality of switches. A first electromagnetic interference (EMI) filter is connected to the first converter. A second converter is connected to the second windings and includes a second plurality of switches. A second EMI filter is connected to the second converter and to a battery. A third converter is connected to the third windings and includes a third plurality of switches. A third EMI filter is connected to the third converter and an alternating current (AC) power outlet. A ground fault circuit interrupter (GFCI) is connected between the third converter and the AC power outlet. A first plurality of configuration switches is configured to selectively connect the first EMI filter to a charge port. A second plurality of configuration switches is configured to selectively connect the first converter to the second converter. A third plurality of configuration switches is configured to selectively connect the third converter to the AC power outlet. A controller is configured to control the first plurality of switches of the first converter, the second plurality of switches of the second converter, the third plurality of switches of the third converter, the first plurality of configuration switches, and the second plurality of configuration switches to select one of a charging mode for charging the battery, a charging/discharging mode for charging the battery from an AC grid via the charge port while supplying power to the AC power outlet, and a discharging/discharging mode for discharging the battery to via the charge port to a load while supplying power to the AC power outlet.

In other features, during the charging mode, the controller is configured to close the first plurality of configuration switches and the second plurality of configuration switches and open the third plurality of configuration switches.

In other features, during the charging mode, the controller is configured to control the first plurality of switches, the second plurality of switches, and the third plurality of switches to supply current from the AC grid through the first converter and the second converter to the third converter and the battery.

In other features, during the charging/discharging mode, the controller is configured to close the first plurality of configuration switches and the third plurality of configuration switches and open the second plurality of configuration switches.

In other features, during the charging/discharging mode, the controller is configured to control the first plurality of switches, the second plurality of switches, and the third plurality of switches to supply current from the AC grid through the first converter to the second converter and the battery and through the first converter and the third converter to the AC power outlet.

In other features, during the discharging/discharging mode, the controller is configured to close the first plurality of configuration switches and the third plurality of configuration switches and open the second plurality of configuration switches.

In other features, during the discharging/discharging mode, the controller is configured to control the first plurality of switches, the second plurality of switches, and the third plurality of switches to supply current from the battery through the second converter and the first converter to the charge port and through the second converter and the third converter to the AC power outlet.

In other features, the AC grid supplies single-phase AC current. The AC grid supplies three-phase AC current.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram and electrical schematic of an example of a battery charging system including an isolated power splitter according to the present disclosure;

FIG. 1B is a functional block diagram and electrical schematic of an example of controller, configuration switches, and converter switches for the battery charging system according to the present disclosure;

FIG. 2 is a more detailed functional block diagram and electrical schematic of an example of converters of the battery charging system according to the present disclosure;

FIG. 3 is a more detailed functional block diagram and electrical schematic of an example of the battery charging system configured in a charging mode according to the present disclosure;

FIG. 4 is a more detailed functional block diagram and electrical schematic of the battery charging system of FIG. 3 configured in a simultaneous charging/discharging mode according to the present disclosure;

FIG. 5 is a more detailed functional block diagram and electrical schematic of the battery charging system of FIG. 3 configured in a discharging/discharging mode according to the present disclosure;

FIG. 6 is a flowchart of an example of a method for controlling configuration switches and converter switches of the battery charging system according to the present disclosure;

FIG. 7 is a more detailed functional block diagram and electrical schematic of an example of the battery charging system connected to a three-phase AC grid according to the present disclosure;

FIG. 8 is an electrical schematic of an example of an electromagnetic interference (EMI) filter according to the present disclosure;

FIG. 9 is a functional block diagram and electrical schematic of another example of a battery charging system including an isolated power splitter according to the present disclosure; and

FIG. 10 is a more detailed functional block diagram and electrical schematic of the battery charging system of FIG. 9.

In the drawings, reference numbers may be reused to identify similar and/or identical elements.

### DETAILED DESCRIPTION

The battery for an electric vehicle (EV), hybrid, and/or fuel cell vehicle includes one or more battery cells, modules, and/or packs. A battery charging system controls charging of the battery via a charge port connected to a utility (or alternating current (AC) grid) and/or supplying power from the battery system to the charge port (for supplying power back to the AC grid or other loads (such as another vehicle, a home, etc.)). The AC grid can supply single-phase or three-phase power.

The vehicle may also include an onboard AC power outlet (such as a 120 volt (V) AC outlet). Some charging systems require the AC power outlet to supply power while charging the vehicle from the AC grid. As can be appreciated, the battery charging system should provide galvanic isolation between the AC power outlet and the AC grid or other components of the battery charging system.

The present disclosure relates to a battery charging system configured to provide vehicle to load (V2L) functionality and galvanic isolation between the AC grid and the AC power outlet (with minimum hardware addition and/or control reconfiguration). The battery charging system is configured to supply power at 120 volts (V) AC while charging from the AC grid or discharging from the battery to the AC grid or another load. The battery charging system is configured to support parallel operation during charging or discharging mode and sharing power between converters of the battery charging system. In some examples, the battery charging system includes a multi-port transformer that provides isolation between the AC grid, the onboard charging module (OBCM), and/or the power splitter.

The battery charging system solves the risk of shorting internal components of the OBCM during simultaneous charging and/or discharging modes since two ground fault circuit interrupter (GFCI) will be present on AC and the AC power outlet side requires bonding to ground.

The battery charging system provides a 120 VAC outlet with isolation from the AC grid. The battery charging system has a reduced size and cost due to the use a multi-port converter. The multi-port converter is connected to a multi-port transformer including multiple windings wound around a common core. The battery charging system provides functional safety at the AC power outlet.

The battery charging system supports supplying power from vehicle to load (V2L) through the onboard AC outlets at the same time that power is supplied through a charge port (normally connected to the AC grid). The battery charging system supports supplying power from vehicle to vehicle (V2V) through the AC power outlet and through the charge port. The battery charging system supports supplying power from the vehicle to grid (V2G) through the charge port and vehicle to vehicle (V2V) and vehicle to home (V2H) through the AC power outlet. The battery charging system provides redundancy and fault tolerant operation of OBCM. The battery charging system also provides the ability to measure leakage current through the AC power outlet.

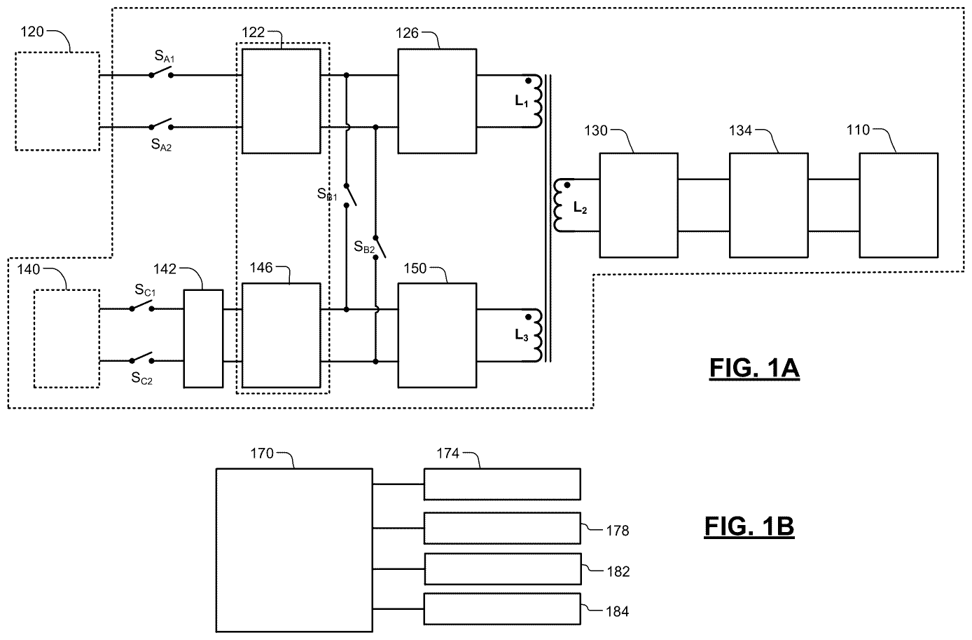

Referring now to FIGS. 1A and 1B, a battery charging system for a vehicle including a battery 110 is shown. A charge port 120 provides a connection to a single-phase or three-phase power system and is selectively connected by configuration switches S_{A1} and S_{A2} through an electromagnetic interference (EMI) filter 122 to a converter 126. An output of the converter 126 is connected to a winding L₁ of a multi-port transformer T. A winding L₂ of the multi-port transformer T (coupled to the windings L₁ and L₃ of the multi-port transformer T) is connected by a converter 130 and an EMI filter 134 to the battery 110.

A winding L₃ of the multi-port transformer T is coupled to the windings L₁ and L₂ of the multi-port transformer T and is selectively connected by a converter 150, an EMI filter 146, a ground fault circuit interrupter (GFCI) 142, and switches S_{C1} and S_{C2} to an AC power outlet 140. Conductors between the EMI filter 122 and the converter 126 are selectively connected by configuration switches S_{B1} and S_{B2} to conductors between the EMI filter 146 and the converter 150. In some examples, the EMI filter 122 and the EMI filter 146 are integrated.

In FIG. 1B, a controller 170 is configured to set states of the configuration switches (S_{A1} and S_{A2} and S_{B1} and S_{B2}) to select an operating mode (e.g., charging the battery 110, charging the battery 110 and discharging through the AC power outlet 140, and discharging the battery 110 and discharging through the AC power outlet 140). The controller 170 is also configured to control configuration switches 174, switches 178 in the converter 126, switches 182 in the converter 130, and switches 184 in the converter 150 to support the selected mode of operation.

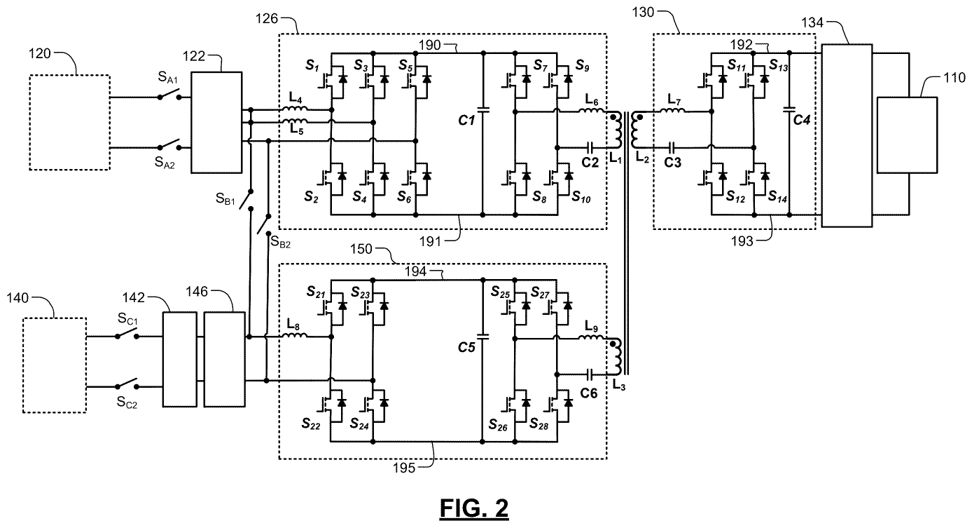

The converters 126, 130, and 150 can include any suitable converters. In some examples, the converters 126, 130, and 150 include two-stage totem pole converters shown in FIGS. 2 to 7 (described further below). In other examples, the converters 126, 130, and 150 include single-stage converters such as matrix converters, electrolytic capacitorless converters, and/or other suitable converters.

Referring now to FIG. 2, the converters 126, 130, and 150 are shown in further detail. The converter 126 includes switch pairs S₁ and S₂, S₃ and S₄, and S₅ and S₆ connected in series between conductors 190 and 191. A node between the pair of switches S₁ and S₂ is connected by an inductor L₄ to the EMI filter 122 and to one terminal of the switch S_{B1}. A node between the pair of switches S₃ and S₄ is connected by an inductor L₅ to the EMI filter 122. In some examples, first terminals of the inductors L₄ and L₅ are shorted at the EMI filter 122. A node between the pair of switches S₅ and S₆ is connected to the EMI filter 122 and to one terminal of the switch S_{B2}. A capacitor C₁ is connected between the conductors 190 and 191.

Pairs of switches (S₇ and S₈) and (S₉ and S₁₀) are connected in series between the conductors 190 and 191. A node between the pair of switches S₇ and S₈ is connected to a first terminal of an inductor L₆. A node between the pair of switches S₉ and S₁₀ is connected to a first terminal of a capacitor C₂. A second terminal of the inductor L₆ is connected to a first terminal of the winding L₁. A second terminal of the capacitor C₂ is connected to a second terminal of the winding L₁.

A first terminal of the winding L₂ is connected to a first terminal of the inductor L₇. A second terminal of the inductor L₇ is connected to a node between a pair of switches S₁₁ and S₁₂ (connected between conductors 192 and 193). A second terminal of the winding L₂ is connected to a first terminal of the capacitor C₃. A second terminal of the capacitor C₃ is connected to a node between a pair of switches S₁₃ and S₁₄ (connected between the conductors 192 and 193). A capacitor C₄ is connected between the conductors 192 and 193. First terminals of the EMI filter 134 is connected to the conductors 192 and 193. The battery 110 is connected to second terminals of the EMI filter 134.

A first terminal of the winding L₃ is connected to a first terminal of an inductor L₉. A second terminal of the inductor L₉ is connected to a node between a pair of switches S₂₅ and S₂₆ (connected between conductors 194 and 195). A second terminal of the winding L₃ is connected to a first terminal of a capacitor C₆. A second terminal of the capacitor C₆ is connected to a node between a pair of switches S27 and S₂₈ (connected between conductors 194 and 195). A capacitor C₅ is connected between the conductors 194 and 195.

Pairs of switches S₂₁ and S₂₂ and S₂₃ and S₂₄ are connected in series between the conductors 194 and 195. A node between the pair of switches S₂₁ and S₂₂ is connected to a first terminal of an inductor L₈ and a second terminal of the switch S_{B1}. A node between the pair of switches S₂₃ and S₂₄ is connected to the EMI filter 146 and a second terminal of the switch S_{B2}. The EMI filter 146 is connected to the GFCI 142 and the AC power outlet 140. In some examples, the EMI filters 122, 134 and 146 include series-connected inductors and grounded capacitors connected between one or more of the series-connected inductors, although other types of EMI filters can be used.

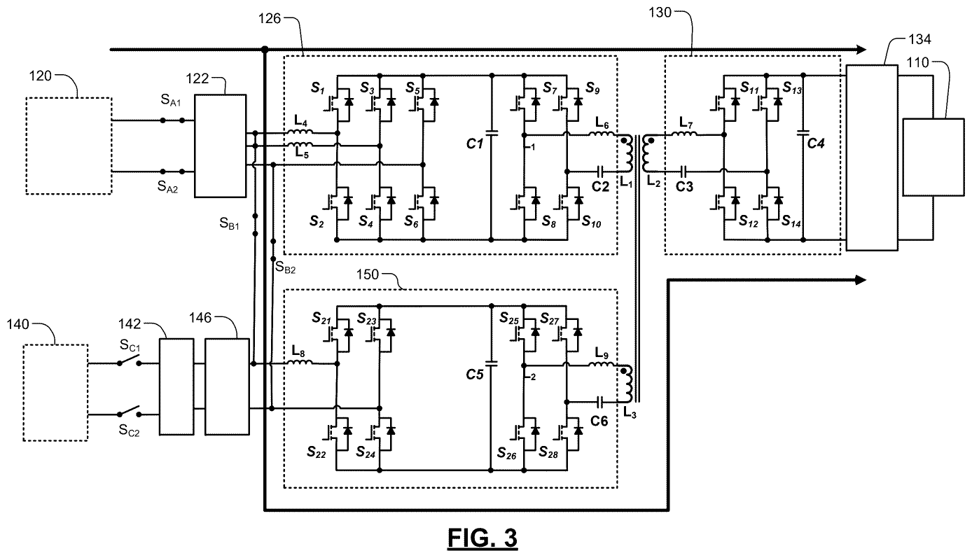

Referring now to FIGS. 3 to 5, operation of the battery charging system is shown. In FIG. 3, the configuration switches S_{A1} and S_{A2} and S_{B1} and S_{B2} are closed and the configuration switches S_{C1} and S_{C2} are open. Switches of the converters 126, 130, and 150 are configured to charge the battery 110. In other words, current flows from the charge port 120 through the converters 126 and 130, the transformer T, and the converter 130 to the battery 110.

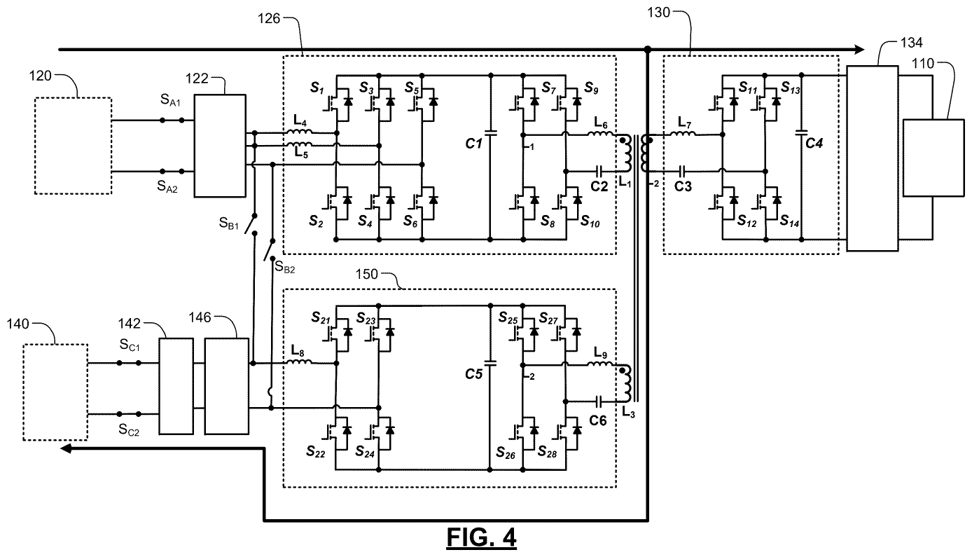

In FIG. 4, the configuration switches S_{A1} and S_{A2} and S_{C1} and S_{C2} are closed and the configuration switches S_{B1} and S_{B2} are open. Switches of the converters 126, 130, and 150 are configured to charge the battery 110 and supply current to the AC power outlet 140. In other words, current flows from the charge port 120, through the converter 126 and transformer T to the converter 130 and the battery 110 and to the converter 150 and the AC power outlet 140.

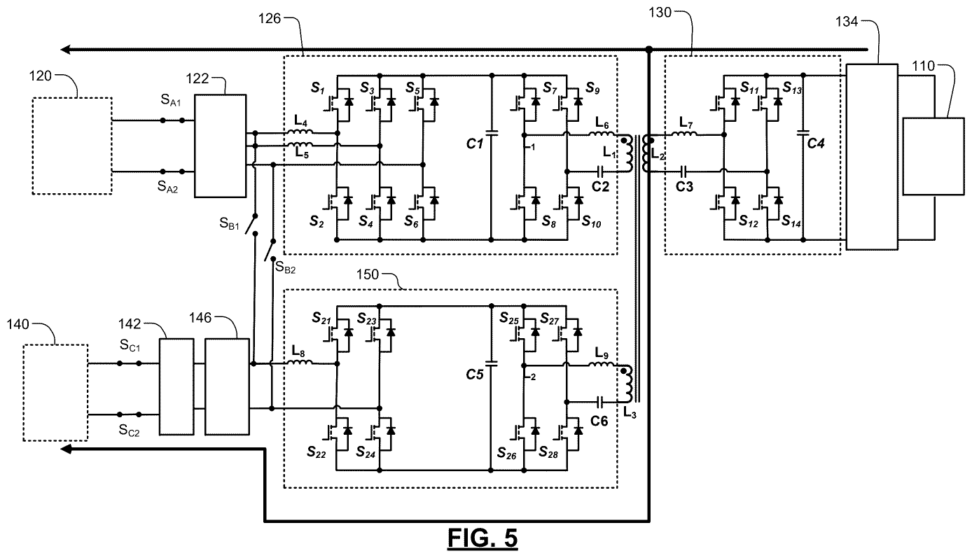

In FIG. 5, the configuration switches S_{A1} and S_{A2} and S_{C1} and S_{C2} are closed and the configuration switches S_{B1} and S_{B2} are open. Switches of the converters 126, 130, and 150 are configured to supply power from the battery 110 to the charge port 120 and to supply power to the AC power outlet 140. In other words, power flows from the battery 110, through the converter 130 and transformer T to the converter 126 and the charge port 120 and to the converter 150 and the AC power outlet 140.

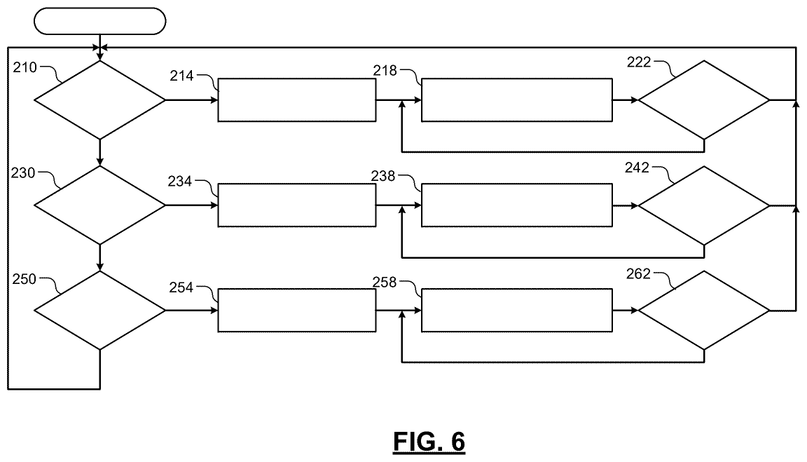

Referring now to FIG. 6, a method for controlling the battery charging system is shown. At 210, the method determines whether a charge mode has been selected. If true, the controller sets states of the configuration switches at 214 and controls converter switches for charging at 218. At 222, the method determines whether the charging mode is done. If true, the method returns to 210. If false, the method returns to 218.

If 210 is false, the method continues with 230. At 230, the method determines whether a charge and discharge mode is selected. If true, the controller sets states of the configuration switches at 234 and controls converter switches for charging and discharging at 238. At 242, the method determines whether the charging and discharging mode is done. If true, the method returns to 210. If false, the method returns to 238.

If 230 is false, the method continues with 250. At 250, the method determines whether a discharge and discharge mode is selected. If true, the controller sets states of the configuration switches at 254 and controls converter switches for discharging and discharging at 258. At 262, the method determines whether the charging and discharging mode is done. If true, the method returns to 210. If false, the method returns to 258.

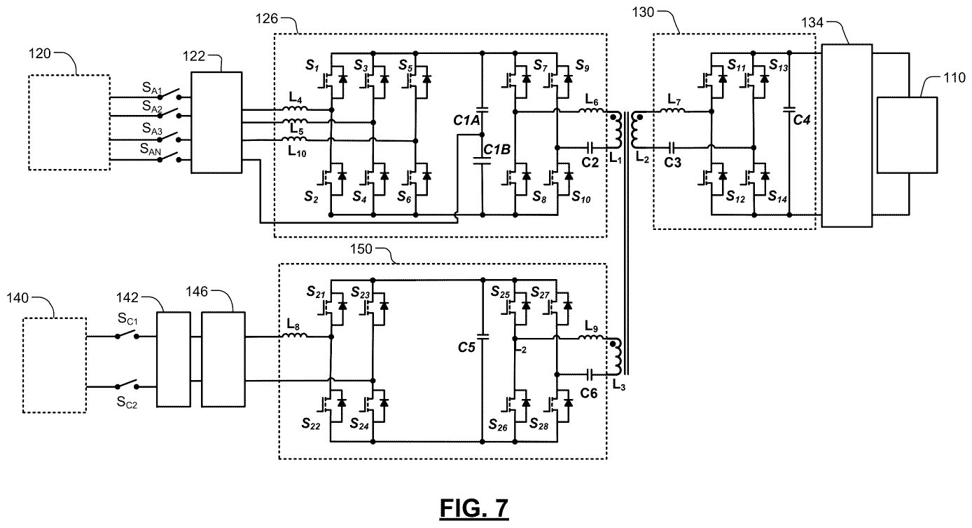

Referring now to FIG. 7, the charge port 120 may include three phases and a neutral line (N) connected by switches S_{A1} to S_{A4}, respectively, to the EMI filter 122. A third phase is selectively connected by the switch S_{A3}, the EMI filter 122 and an inductor L₁₀ to a node between the pair of switches S₅ and S₆. Capacitor C₁ is replaced by capacitors C_{1A} and C_{1B} connected in series between the conductors 190 and 191. The neutral phase is connected to a node between the capacitors C_{1A} and C_{1B}. The configuration switches S_{B1} and S_{B2} are omitted.

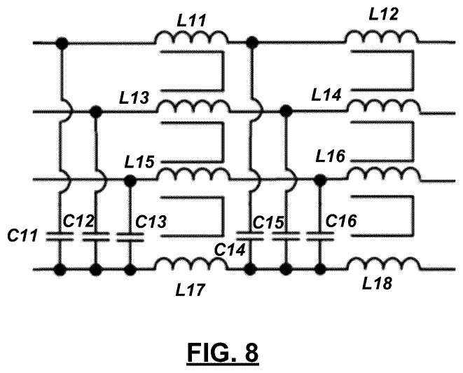

Referring now to FIG. 8, an example of the EMI filter is shown for a three-phase AC grid. Series connected inductor pairs L₁₁ and L₁₂, L₁₃ and L₁₄, L₁₅ and L₁₆, and L₁₇ and L₁₈ are connected to the three phases and the neutral line, respectively. Capacitors C₁₁ to C₁₆ are connected to first and second terminals of one or more inductors of the series-connected inductor pairs L₁₁ and L₁₂, L₁₃ and L₁₄, L₁₅ and L₁₆, and L₁₇ and L₁₈.

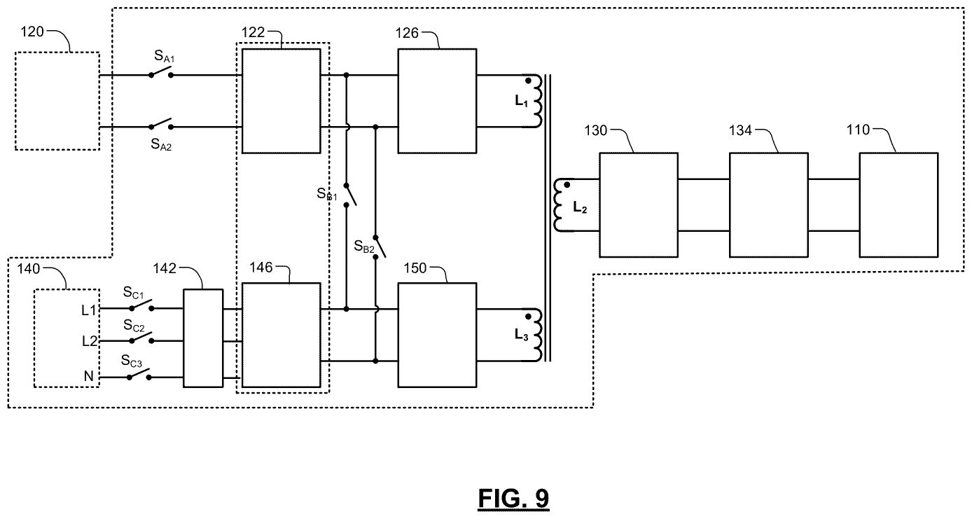

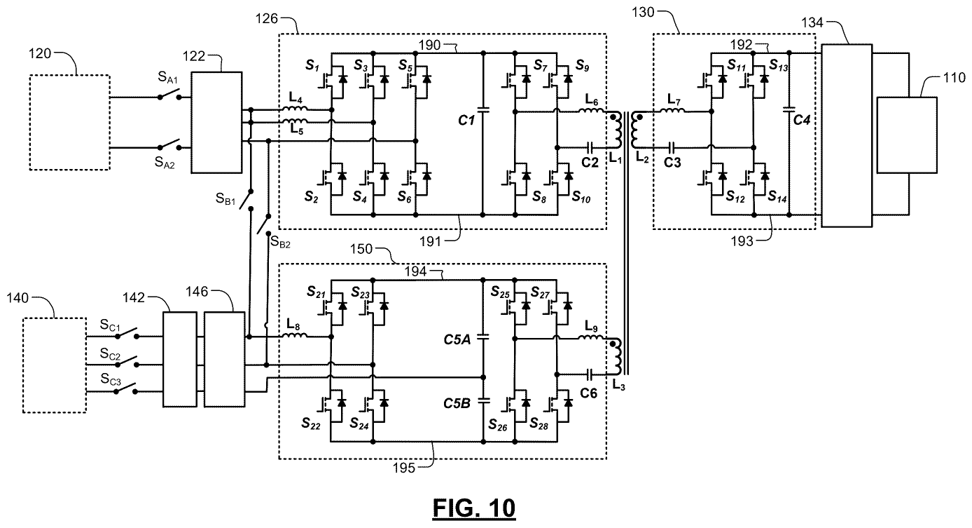

Referring now to FIGS. 9 and 10, configuration switches S_{C1}, S_{C2}, and S_{C3} are provided for lines L1, L2, and N. The capacitor C₅ is replaced by capacitors C5A and C_{5B} connected between the conductors 194 and 195. The configuration switch S_{C3} is connected to a node between the capacitors C5A and C_{5B}. The configuration shown in FIGS. 9 and 10 support an AC outlet with split-phase 120V/240V power (L1-N-L2).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed. ” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A battery charging system for a vehicle comprising:
a multi-port transformer including first windings, second windings, and third windings wound around a common core;
a first converter connected to the first windings and including a first plurality of switches;
a second converter connected to the second windings and a battery and including a second plurality of switches;
a third converter connected to the third windings and to an alternating current (AC) power outlet and including a third plurality of switches;
a first plurality of configuration switches configured to selectively connect the first converter to a charge port; and
a controller configured to control the first plurality of switches of the first converter, the second plurality of switches of the second converter, the third plurality of switches of the third converter, the first plurality of configuration switches, and the second plurality of configuration switches to select one of a plurality of charging modes of the battery charging system.

2. The battery charging system of claim 1, further comprising:
a ground fault circuit interrupter (GFCI) connected between the third converter and the AC power outlet;
a second plurality of configuration switches configured to selectively connect the first converter to the second converter; and
a third plurality of configuration switches configured to selectively connect the third converter to the AC power outlet.

3. The battery charging system of claim 2, wherein the plurality of charging modes include:
a charging mode for charging the battery,
a charging/discharging mode for charging the battery from an AC grid via the charge port while supplying power to the AC power outlet, and
a discharging/discharging mode for discharging the battery to a load via the charge port while supplying power to the AC power outlet.

4. The battery charging system of claim 3, wherein, during the charging mode, the controller is configured to close the first plurality of configuration switches and the second plurality of configuration switches and open the third plurality of configuration switches.

5. The battery charging system of claim 4, wherein, during the charging mode, the controller is configured to control the first plurality of switches, the second plurality of switches, and the third plurality of switches to supply current from the AC grid through the charge port, the first converter and the second converter to the third converter and the battery.

6. The battery charging system of claim 3, wherein, during the charging/discharging mode, the controller is configured to close the first plurality of configuration switches and the third plurality of configuration switches and open the second plurality of configuration switches.

7. The battery charging system of claim 6, wherein, during the charging/discharging mode, the controller is configured to control the first plurality of switches, the second plurality of switches, and the third plurality of switches to supply current from the AC grid through the first converter to the second converter and the battery and through the first converter and the third converter to the AC power outlet.

8. The battery charging system of claim 3, wherein, during the discharging/discharging mode, the controller is configured to close the first plurality of configuration switches and the third plurality of configuration switches and open the second plurality of configuration switches.

9. The battery charging system of claim 8, wherein, during the discharging/discharging mode, the controller is configured to control the first plurality of switches, the second plurality of switches, and the third plurality of switches to supply current from the battery through the second converter, the first converter, and the charge port and through the second converter and the third converter to the AC power outlet.

10. The battery charging system of claim 3, wherein the AC grid supplies three-phase AC current.

11. The battery charging system of claim 3, wherein the AC grid supplies single-phase AC current.

12. A battery charging system for a vehicle comprising:
a multi-port transformer including first windings, second windings, and third windings wound around a common core;
a first converter connected to the first windings and including a first plurality of switches;
a first electromagnetic interference (EMI) filter connected to the first converter;
a second converter connected to the second windings and including a second plurality of switches;
a second EMI filter connected to the second converter and to a battery;
a third converter connected to the third windings and including a third plurality of switches;
a third EMI filter connected to the third converter and an alternating current (AC) power outlet;
a ground fault circuit interrupter (GFCI) connected between the third converter and the AC power outlet;
a first plurality of configuration switches configured to selectively connect the first EMI filter to a charge port;
a second plurality of configuration switches configured to selectively connect the first converter to the second converter;
a third plurality of configuration switches configured to selectively connect the third converter to the AC power outlet; and
a controller configured to control the first plurality of switches of the first converter, the second plurality of switches of the second converter, the third plurality of switches of the third converter, the first plurality of configuration switches, and the second plurality of configuration switches to select one of:
a charging mode for charging the battery,
a charging/discharging mode for charging the battery from an AC grid via the charge port while supplying power to the AC power outlet, and
a discharging/discharging mode for discharging the battery to via the charge port to a load while supplying power to the AC power outlet.

13. The battery charging system of claim 12, wherein, during the charging mode, the controller is configured to close the first plurality of configuration switches and the second plurality of configuration switches and open the third plurality of configuration switches.

14. The battery charging system of claim 13, wherein, during the charging mode, the controller is configured to control the first plurality of switches, the second plurality of switches, and the third plurality of switches to supply current from the AC grid through the first converter and the second converter to the third converter and the battery.

15. The battery charging system of claim 12, wherein, during the charging/discharging mode, the controller is configured to close the first plurality of configuration switches and the third plurality of configuration switches and open the second plurality of configuration switches.

16. The battery charging system of claim 15, wherein, during the charging/discharging mode, the controller is configured to control the first plurality of switches, the second plurality of switches, and the third plurality of switches to supply current from the AC grid through the first converter to the second converter and the battery and through the first converter and the third converter to the AC power outlet.

17. The battery charging system of claim 12, wherein, during the discharging/discharging mode, the controller is configured to close the first plurality of configuration switches and the third plurality of configuration switches and open the second plurality of configuration switches.

18. The battery charging system of claim 17, wherein, during the discharging/discharging mode, the controller is configured to control the first plurality of switches, the second plurality of switches, and the third plurality of switches to supply current from the battery through the second converter and the first converter to the charge port and through the second converter and the third converter to the AC power outlet.

19. The battery charging system of claim 12, wherein the AC grid supplies single-phase AC current.

20. The battery charging system of claim 12, wherein the AC grid supplies three-phase AC current.
